(19) United States
(12) Patent Application Publication
(10) Pub. No.: US 2022/0144421 A1
(43) Pub. Date: May 12, 2022

(54) ELECTRICALLY POWERED VTOL AIRCRAFT FOR PROVIDING TRANSPORTATION

(71) Applicant: Airspace Experience Technologies, Inc., Detroit, MI (US)

(72) Inventors: Jon Rimanelli, Detroit, MI (US); Qhase Lokhandwala, Detroit, MI (US)

(73) Assignee: Airspace Experience Technologies, Inc., Detroit, MI (US)

(21) Appl. No.: 17/520,929

(22) Filed: Nov. 8, 2021

Related U.S. Application Data
(63) Continuation of application No. PCT/US2020/032107, filed on May 8, 2020.
(60) Provisional application No. 62/844,991, filed on May 8, 2019.

(51) Int. Cl. B64C 29/00; B64D 27/24; B64C 3/38; B64D 31/00; B64C 25/10

(52) U.S. Cl. CPC B64C 29/0033; B64D 27/24; B64C 2211/00; B64D 31/00; B64C 25/10; B64C 3/385

(57) ABSTRACT

An electrically powered vertical takeoff and landing aircraft (EVTOL) includes a payload module, a plurality of electrical power sources. a wing, and a plurality of electric thrust generators. The wing is pivotally attached to the payload module and is configured to pivot about a pivot axis, relative to the payload module, to transition between vertical flight and horizontal flight. The electric thrust generators are operatively attached to the wing, where each one is operatively connected to a different electrical power source. The electric thrust generators operate to provide thrust to the aircraft in response to receiving electric power from the electrical power sources. The electric thrust generators pivot, with the wing, about the pivot axis, relative to the payload.

### CROSS-REFERENCE TO RELATED APPLICATION

This application claims priority of U.S. Provisional Application No. 62/844,991, filed on May 8, 2019.

### TECHNICAL FIELD

The present disclosure relates to an electrically powered VTOL aircraft for providing transportation to passengers and/or cargo.

### BACKGROUND

A vertical take-off and landing (VTOL) aircraft is one that can take-off and land vertically, relative to the ground. The VTOL can also hover relative to the ground. Additionally, the VTOL aircraft can transition between the vertical movement, relative to the ground, and horizontal flight. A vertical and short take-off and landing (VSTOL) aircraft is similar to the VTOL aircraft, but is also configured to utilize a short forward ground roll and resultant velocity to transfer apportion of the lift required by the aircraft to a wing, prior to take-off. to allow the aircraft to take-off with a higher take-off weight than could be achieved with only a VTOL aircraft.

### SUMMARY

One aspect of the disclosure includes an electrically powered VTOL aircraft configured to transition between vertical flight and horizontal flight. The aircraft includes a payload module, a wing module, a tail module, a ground module, a plurality of electric thrust generators, and at least one electrical power source. The ground module is operatively attachable to the payload module is configured to operatively support the aircraft when positioned on the ground. The electric thrust generators are operatively attached to the wing. The electric thrust generators are configured to operate to provide thrust to the aircraft in response to receiving electric power from the at least one electrical power source. The wing module is configured to selectively pivot about the pivot axis, relative to the payload module and the tail section, to vary a flight path of the aircraft from between a first position and a second position. Each of the plurality of electric thrust generators pivot with the wing about the pivot axis, relative to the payload. The aircraft is configured for vertical flight when the wing is in the first position and the plurality of electric thrust generators are operating when the wing is in the first position and the aircraft is configured for horizontal forward flight, relative to the ground, when the wing is in the second position and the plurality of electric thrust generators are operating.

### BRIEF DESCRIPTION OF THE DRAWINGS

FIG. 1 is a schematic isometric view of an electrically powered aircraft having a payload module and a ground module including a wing, with the wing oriented in a first position that is configured for vertical flight;

FIG. 2 is a schematic isometric view of the VTOL aircraft of FIG. 1, with the wing oriented in a second position;

FIG. 3 is a schematic top view of the VTOL aircraft of FIG. 1, with the wing oriented in the first position;

FIG. 4 is a schematic front view of the VTOL aircraft of FIG. 1, with the wing oriented in the first position;

FIG. 5 is a schematic right side view of the VTOL aircraft of FIG. 1, with the wing in the first position;

FIGS. 6A-6C is a schematic right side view of the VTOL aircraft transitioning between the first position of FIG. 1 and the second position of FIG. 2;

FIG. 7A is a schematic top view of a payload module and tail module of the VTOL aircraft of FIG. 1;

FIG. 7B is a schematic front view of the payload module and tail module of FIG. 7A;

FIG. 7C is a schematic right side view of the payload module and tail module of FIG. 7A;

FIG. 8 is a schematic exploded view of a right side of the VTOL aircraft of FIG. 1;

FIGS. 9A-9C are schematic top perspective views of the tail module of FIGS. 6A-6C;

FIGS. 9D-9F are schematic side views of the tail module of FIGS. 6A-6C and 9A-9C, respectively;

FIGS. 10A-10D are schematic illustrative views of an alternative embodiment of tail module showing a ducted fan with the V tail;

FIG. 11 is a schematic isometric view of an alternative embodiment of the VTOL aircraft of FIG. 2 with a pair of stacked sets of propellers on each thrust generator, with the thrust generators disposed along a single row of the wing;

FIG. 12 is a schematic isometric view of an alternative embodiment of another VTOL aircraft of FIG. 1 with a T tail configuration;

FIG. 13 is a schematic isometric view of another embodiment of the aircraft of FIG. 2 with an H configuration;

FIG. 14 is a schematic top view of the aircraft of FIG. 13;

FIG. 15 is a schematic front view of the aircraft of FIG. 13;

FIG. 16 is a schematic right side view of the aircraft of FIG. 13;

FIGS. 17A-17C are schematic right side views of the VTOL aircraft transitioning between the first position of FIG. 13 and a second position;

FIG. 18 is a schematic isometric view of another embodiment of the aircraft of FIG. 2 with an H configuration;

FIG. 19 is a schematic top view of the aircraft of FIG. 18;

FIG. 20 is a schematic front view of the aircraft of FIG. 18;

FIG. 21 is a schematic right side view of the aircraft of FIGS. 18; and

FIGS. 22A-22C are schematic right side views of the VTOL aircraft transitioning between the first position of FIG. 18 and a second position.

### DETAILED DESCRIPTION

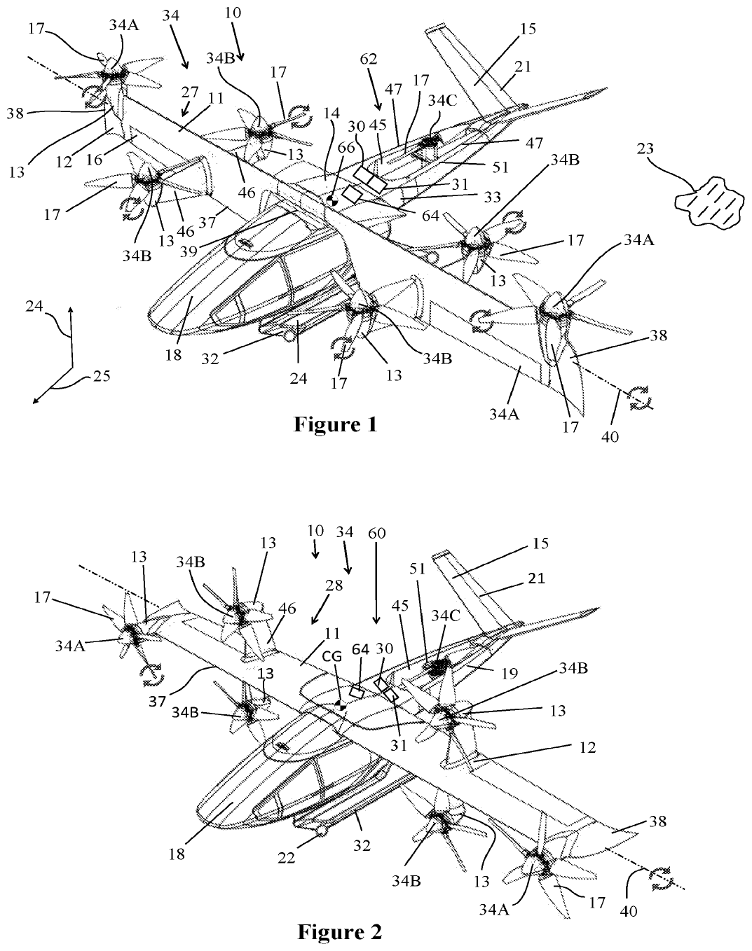

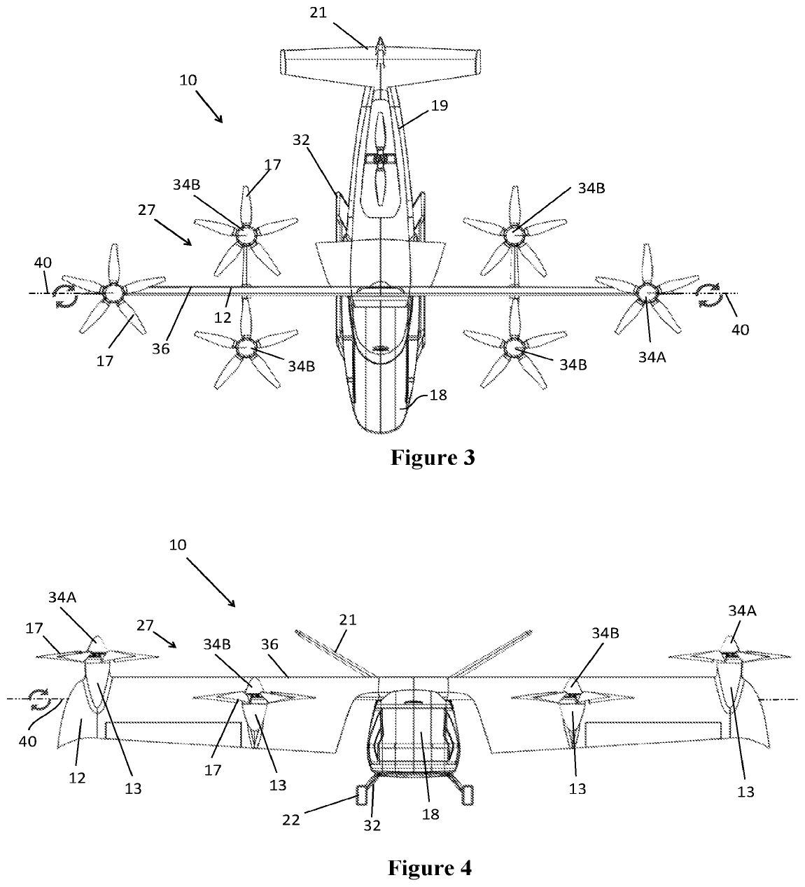

Referring to the drawings, wherein like reference numerals are used to identify like or identical components in the various views, FIGS. 1-5 and 6A-6C show an electrically powered vertical takeoff and landing (VTOL) aircraft at 10. As will be explained in more detail below, the electrically powered aircraft 10 (hereinafter “aircraft”) is configured to takeoff in a vertical direction 24 (see FIG. 6A), fly in a horizontal direction 25 (see FIG. 6C) and transition between vertical and horizontal flights (see FIG. 6B). The aircraft 10 is configured to provide transport for passengers and/or cargo between locations in a payload module 18. When not in use, or when loading/unloading the passengers and/or cargo, the aircraft 10 may include landing gear 26 that rests on the ground 23 to that supports the aircraft 10.

The aircraft 10 includes a wing module 12, the payload module 18, a tail module 19, a ground module 32, a plurality of electric thrust generators 34, and a control system 20. The control system 20 includes at least one electrical power source 30, a controller 31, and a plurality of sensors 33. The control system 20 may include a plurality of power sources 30. The ground module 32 is operatively attached to the payload module 18, and may include landing gear 26, wheels 22, and the like.

As will be explained in more detail below, the aircraft 10 is configured to provide differential thrust, by virtue of the plurality of electric thrust generators 34; the flexibility of a fixed or a modular payload approach; the incorporation of higher aspect ratio wing to enhance performance of the aircraft 10; and the addition of a rearward extended tail section 21 enhances dynamic stability of the aircraft 10 by incorporating both integrated electric thrust generators 34 mounted on a tail boom 35 and a conventional aircraft tail section 21 control surfaces.

The landing gear 26 is configured to operatively support the aircraft 10 when the aircraft 10 is positioned on the ground 23. The wheels 22 may be configured to provide the utility of taxiing the aircraft 10 and generally allow for movement of the aircraft 10 on the ground 23.

The wing module 12 includes a wing section 11, a wing box 14, and a pivot mechanism 39. The wing module 12 is operatively attached to the payload module 18. With reference to FIG. 1, the pivot mechanism 39 is schematically illustrated at 39. The pivot mechanism 39 pivotally connects the wing 12 to the payload module 18 such that the wing 12 is selectively pivotable about a pivot axis 40, relative to the payload module 18 and the tail module 19 to vary a flight path of the aircraft 10 from between a first position 27 (shown in FIG. 1) and a second position 28 (shown in FIG. 2). Referring now to FIG. 6A, when the wing module 12 is in the first position 27 (i.e., in a vertical flight mode), the aircraft 10 is configured for vertical flight 24. Referring now to FIG. 6C, when the wing module 12 is in the second position 28 (i.e., in a horizontal flight mode), the aircraft is configured for horizontal flight 25. Likewise, when the wing module 12 is transitioning between the first position 27 and the second position 28, the wing module is in a transition flight mode 29. In one non-limiting embodiment, the controller 31 may receive an input or command to vary the flight path of the aircraft 10. As a result of receiving the command, the orientation of the wing module 12 relative to the payload module 18 and the tail module 19 may be varied in response to the pivot mechanism receiving a command signal from the controller 31.

This pivotal connection between the wing 12 and the payload module 18 is configured to support vertical loads, lifting loads, and additional loads due to component loading during flight of the aircraft 10.

Referring again to FIGS. 1 and 2, the wing box 14 of the wing module 12 is configured to hold the pivoting mechanism 39 and provide a storage area for necessary systems, such as avionics and the like.

Referring again to FIGS. 1 and 2, the wing 12 includes the leading edge 36 and a trailing edge 37, opposite the leading edge 36. Side edges 38 along the wing chord extend to connect the leading edge 36 and the trailing edge 37. The wing module 12 may include a plurality of control surfaces, such as ailerons/elevators 16, proximate the trailing edge 37.

A plurality of electric thrust generators 34 (hereinafter “thrust generators”) are operatively attached to the wing 12 and the tail section 19 to provide differential thrust to the aircraft 10.

In the embodiment illustrated in FIGS. 1-5 and 6A-6C, six thrust generators 34 (shown as 34A, 34B) are mounted on the wing module 12. The thrust generators 34 may include a pair of opposing wing tip thrust generators 34A, each located at the leading edge 36 and proximate the respective side edge 38. Through interaction with wing tip vortices, the wing tip thrust generators 34A are configured to assist in improving the efficiency of the wing module 12 during horizontal flight 25. The thrust generators 34 also include four differential thrust generators 34B attached to the wing section 11 in an H-mount configuration. More specifically, each of the differential thrust generators 34B are attached to an opposing surface (i.e., upper surface and lower surface) of the wing section 11 via a wing boom 46. As such, a pair of the differential thrust generators 34B are attached to the wing section 11 on opposing sides of the payload module 18, resulting in the H-mount configuration shown in FIGS. 1-5. The differential thrust generators 34B operate to provide differential thrust to the aircraft 10 by helping to control the wing section 11 in the vertical flight mode 27 and in the transition mode 29. The differential thrust generators 34B are operatively attached to the wing section 11 to ensure the thrust plane of the H-mount configuration is in line with the pivot axis, which is in line with the mean aerodynamic chord of the wing section 11, to provide a smooth transition from vertical flight 24 to horizontal flight 25.

It should be appreciated, however, that more or fewer thrust generators 34 may be used in order to achieve the desired flight control and dynamics of the aircraft.

Referring generally to FIGS. 1-5 and 6A-6C, in one aspect, the electric thrust generators 34 are individually selectively operable to provide thrust to the aircraft 10 in response to receiving electric power from at least one electrical power source 30. For redundancy, the electric thrust generators 34 may be configured to receive power from more than one power source 30, in order to provide redundancy in power supply to each of the electric thrust generators 34 during operation. The electrical power source 30 may be a battery storage system or a battery management system 30. Further, the entirety of the electric thrust generators 34 may be configured to pivot with the wing section 11 about the pivot axis 40 to provide thrust vectoring, i.e., directs the thrust in an intended direction.

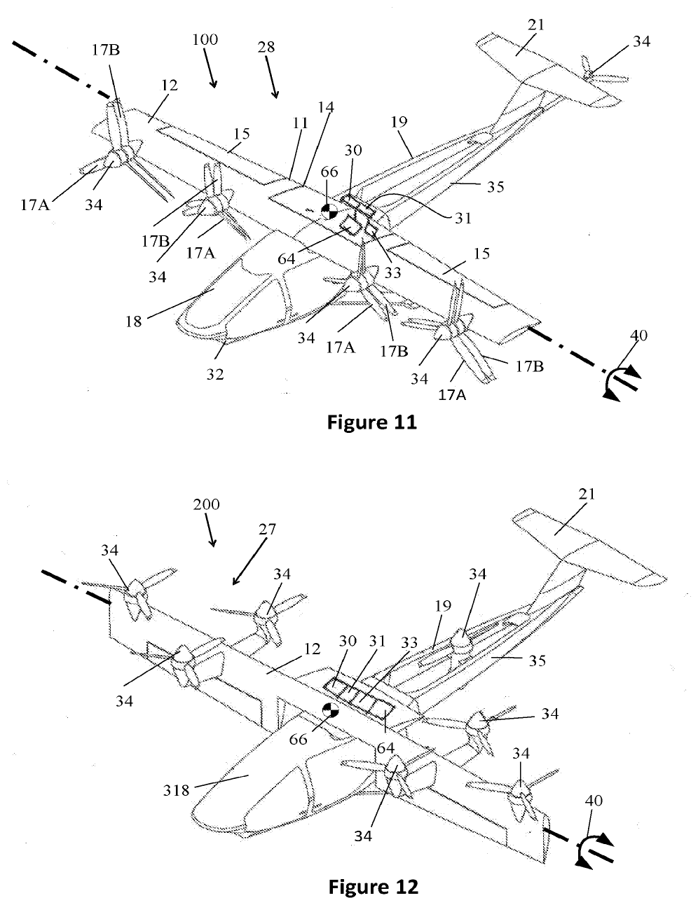

The tail module 19 is operatively attached to the payload module 18. The tail module 19 includes a tail boom 35 and a tail section 21. The tail boom 35 extends from the payload module 18, as shown in FIG. 1. The tail section 21 extends from the tail boom 35. The tail section 21 includes control surfaces, such as ailerons/elevators 16. The control surfaces are configured to controlling the dynamic stability of the aircraft 10 in horizontal flight mode 28. As shown in FIGS. 1 and 2, the aircraft 10 includes a V tail shaped tail section 21 (i.e., a butterfly tail or V-butterfly tail) that opens upward. It should be appreciated that the tail section 21 may be configured with a V tail that opens downward (i.e., an inverted butterfly tail). The tail section 21 is not limited to having a V tail shape, as other shaped tails may also be included, such that the T tail shape shown in the embodiments of FIGS. 11 and 12. Other shaped tail sections 21 may also be included.

Referring generally to FIGS. 1 and 2, the tail boom 35 may define an opening 45 extending therethrough between an upper surface 47 and a lower surface 49 thereof, where the lower surface 49 generally faces the ground 23 when the aircraft 10 is positioned on the ground and the upper surface 47 faces opposite the lower surface 49. A strut 51 extends through the opening 45 to provide an attachment location for at least one thrust generator 34 (i.e., tail thrust generator 34C) thereto.

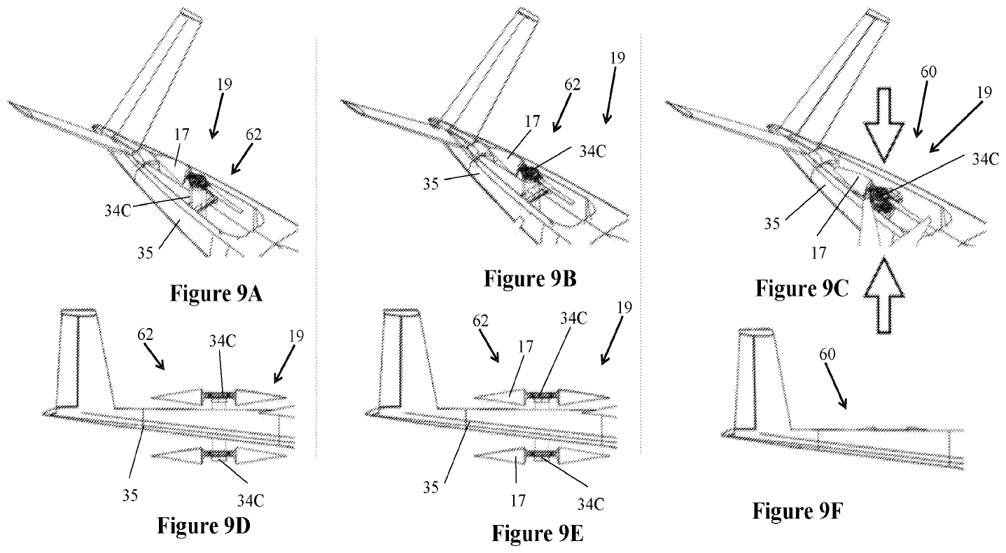

With specific reference to FIGS. 6A-6C and 9A-9F, a pair of tail thrust generators 34C are attached to the strut 51 in a tail boom 35, in opposition to one another. As illustrated in FIGS. 2, 6C, 9C, and 9F, the tail thrust generators 34C be may be configured to be disposed within the opening, in a retracted position 60. Likewise, as illustrated in FIGS. 1, 6A, 6B, 9A, 9B, 9D, and 9E the tail thrust generators 34C may be configured to be extended outward from the opening 45 for operation, when in an extended position 62. The tail thrust generators 34C may be operable to assist with lift and pitch control during vertical 27 and transition flight modes 29 of the aircraft 10. The tail thrust generators 34C may be retracted on the tail boom 35 during the horizontal flight mode 28 to reduce drag on the aircraft 10.

The aircraft 10 is configured for vertical flight when the wing 12 and the associated electric thrust generators 34 are in the second position, as illustrated in FIGS. 1-4 and as illustrated in FIG. 9 (see element 100-4). When the electric thrust generators 34 are selectively operating and providing thrust, and the wing 12 is in the second position, the aircraft 10 flies vertically. Likewise, the aircraft 10 is configured for horizontal, forward flight when the wing 12 and the associated electric thrust generators 34 are in the first position, as illustrated in FIG. 9 as elements 100-7, 100-8, and 100-9. When the electric thrust generators 34 are selectively operating and providing thrust, and the wing 12 is in the first position, the aircraft 10 flies horizontally in a forward direction, relative to the ground 23.

Each electric thrust generators 34 (34A, 34B, 34C) may include an electric motor 13 and a propeller 17. The electric motors 13 are operatively attached to the wing section 11 and are in electrical communication with the electrical power source 30. The propellers 17 are rotatably attached to the respective electric motor 13. In response to receiving electrical power, i.e., an electrical signal, from the electrical power source 30, the propellers 17 are configured to selectively rotate about a prop axis and generate thrust to lift the aircraft 10 vertically 24 when the wing 12 is in the vertical flight mode 27, i.e., in a VTOL mode, and propel the aircraft 10 forward in the horizontal direction 25 when the wing section 11 is in the horizontal flight mode 28.

In one non-limiting example, the propellers 17 may be attached to the electric motor 13 to allow a pitch of the propeller 17 blade to be actively varied. Allowing the pitch of the propeller 17 blades of one or more of the thrust generators 34 to be varied during flight in any of the modes 27, 28, and 29 would provide near instantaneous response in the dynamics of the aircraft 10, when compared with the dynamic response that would result from only varying a speed of one or more of the motors 13 or varying the angle of the wing section 11. Thus, as sensors 33 of aircraft 10 detect sudden impending changes in the wind that may affect the aircraft 10 dynamics, the pitch of the blades of one or more propeller 17 sets may be immediately varied to mitigate the effects on the aircraft 10 performance.

The differential thrust generators 34B are configured such that the propellers 17 of one differential thrust generator 34B rotate counter to the direction of rotation of the adjacent two differential thrust generators 34B. This counter rotation between the adjacent electric thrust generators 34B aids in controlling the stability of the aircraft 10 while the aircraft 10 is in the vertical flight mode 27 and when the aircraft 10 is in a transition flight mode 29 (i.e., when the wing section 11 is rotating between the vertical flight mode 27 and the horizontal flight mode 28).

The controller 31 may be in operative communication with the pivot mechanism 39, the electric motors 13 of each of the thrust generators 34A, 34B, 34C, and the pivot actuator of each of the propellers 17. Thus, during flight, any one of the pivot mechanism 39, the electric motors 13, and the pitch of the propellers 17 may be varied to vary the thrust and control the dynamics of the aircraft 10.

Additionally, with reference to FIG. 1, the aircraft 10 may be configured with a variability system 64 to actively vary a center of gravity (CG) 66 of the aircraft 10. Such variability may be required during transition between the flight modes 27, 28, and 29, the amount and position of a payload within the payload module 18, aircraft 10 speed, and/or the like. Allowing for the movement of the CG in the fore/aft direction 42, for example, may provide improved stability to the aircraft 10 and optimized aircraft 10 control during aircraft takeoff, flight, landing, and transitions between the flight modes 27, 28, and 29 of FIGS. 6A, 6B, and 6C, respectively.

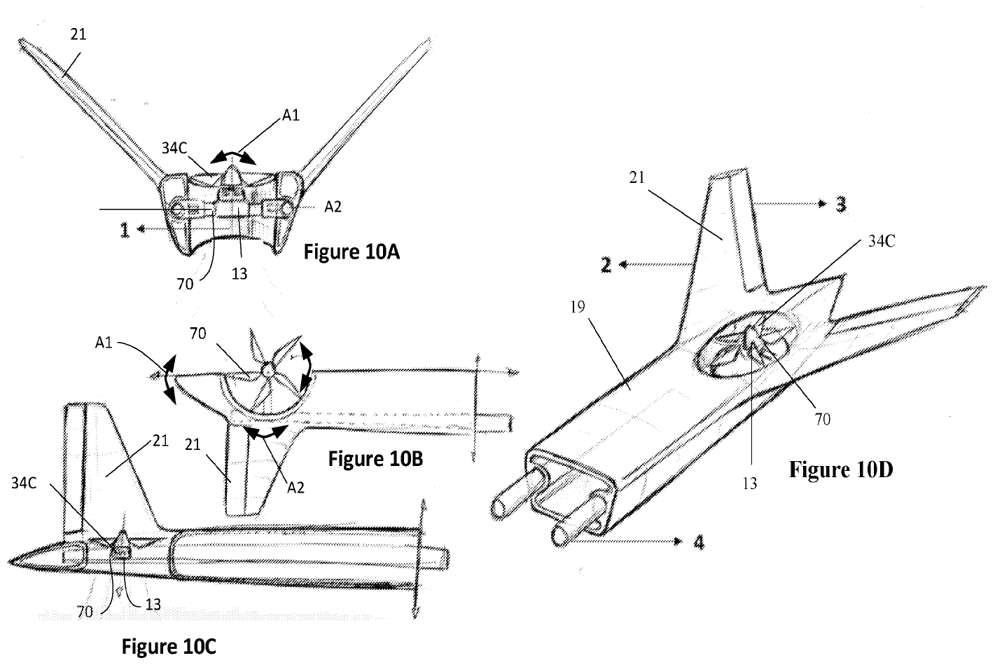

With reference to FIGS. 10A-10D, another embodiment of the tail section 21 is illustrated. The tail section 21 a thrust generator 34C that is a ducted fan 70. The ducted fan 70 may be configured to pivot around a first axis A1 and/or a second axis A2, relative to the tail section 21, to vary the vector thrust or change the pitch of the aircraft 100. The tail section 21 may also include modular attachment rods 71 to allow for attachment to and detachment from the payload module 18 or another aircraft 100 feature.

With reference to the embodiment shown in FIG. 11, another embodiment of the aircraft 100 is shown as including four thrust generators 34 that are operatively attached to the wing section 11, approximate the leading edge, in a single row. Two thrust generators 34 are disposed on opposing sides of the payload module 18. Two sets of propellers 17A, 17B are attached to each thrust generator, where each set of propellers 17A, 17B rotates in an opposite direction to the other set of propellers 17A, 17B to provide the requisite differential thrust. As such, for each thrust generator 34, while the set of propellers designated as 17A will rotate in one direction, the set of propellers designated as 17B will rotate in an opposite direction (counter rotates). However, it should be appreciated that every set of propellers designated as 17A does not have to rotate in the same direction as every other set of propellers designated as 17A. Likewise, the same is true for the sets of propellers designated as 17B. It should also be appreciated that the number of thrust generators 34 is not limited to having only four thrust generators 34, as more or fewer thrust generators 34 may also be used. Additionally, as with the embodiment described above, each of the propellers 17A, 17B may be configured for active control of a pitch of the respective propeller blades to control the aircraft 10 during flight.

Additionally, with continued reference to FIG. 11, the aircraft 100 includes a thrust generator 34 that extends aft of the tail section 35. Location of the thrust generator 34 after of the tail section 35 may provide control of the pitch of the aircraft 100 during flight. The tail section 35 may be a T-tail configuration.

FIG. 12 shows another embodiment of the aircraft 10 of FIG. 1, with a T-tail configuration.

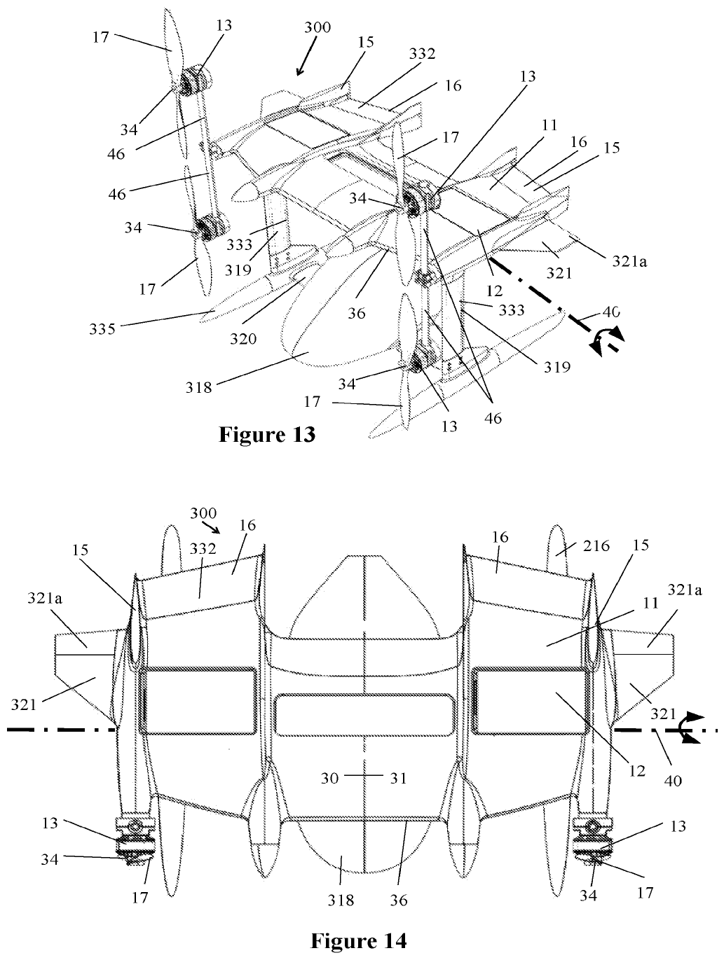

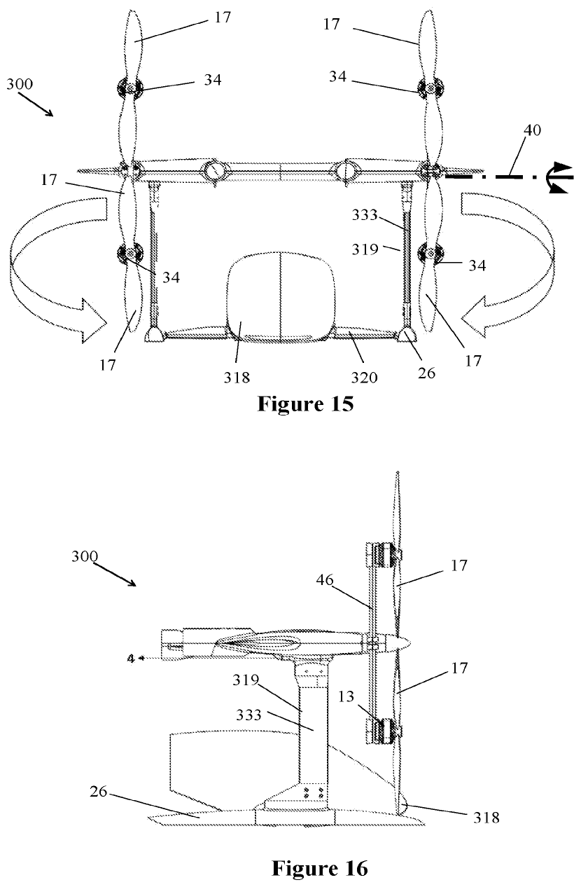

With reference to the embodiment of the aircraft 300 shown in FIGS. 13-16 and 17A-17C, the aircraft 300 includes a payload module 318, at least one electrical power source 30, a controller 31, and a flight module 332. The flight module 332 is operatively attachable to the payload module 318. The flight module 332 may include a structure 333, a wing 12, the landing gear 26, and a plurality of electric thrust generators 34.

The structure 333 may include a pair of stanchions 319 and a pair of arms 320. The pair of stanchions 319 extend from the wing 12 in spaced and parallel relationship to one another, with payload module 318 disposed therebetween. The pair of arms 320 extend toward one another, from a respective stanchion to attach to opposing sides of the payload module 318. The arms 320 may be removably connectable to the payload module 318 to allow the payload module 318 to be selectively disconnected from the structure 333 of the flight module 332.

The landing gear 26 is configured to operatively support the aircraft 300 when the aircraft 300 is positioned on the ground 23. The landing gear 26 may be operatively attached to the structure 333. In the embodiment shown in FIGS. 1-4 and FIG. 9, the landing gear 26 includes a pair of bases 335 and a plurality of wheels 22. A base is operatively attached to the structure 333, proximate an intersection of the respective stanchion and the respective arm. In the embodiment shown in FIGS. 1-4, the landing gear 26 is in a fixed position, meaning the landing gear 26 remains in a deployed position, regardless of whether the aircraft 300 is positioned on the ground 23 or in flight. The wheels 22 may be configured to provide the utility of taxiing the aircraft 300 and generally allow for movement of the aircraft 300 on the ground 23.

The electric thrust generators 34 are operatively attached to the wing 12. The electric thrust generators 34 are selectively operable to provide thrust to the aircraft 300 in response to receiving electric power from the electrical power source 30. The electrical power source 30 may be a battery storage system or a battery management system. The electric thrust generators 34 are typically attached to the wing 12 at or proximate a leading edge 36 of the wing 12. The embodiment shown in FIGS. 13-16 includes four electric thrust generators 34 disposed in spaced relationship to one another across the leading edge 36 of the wing 12.

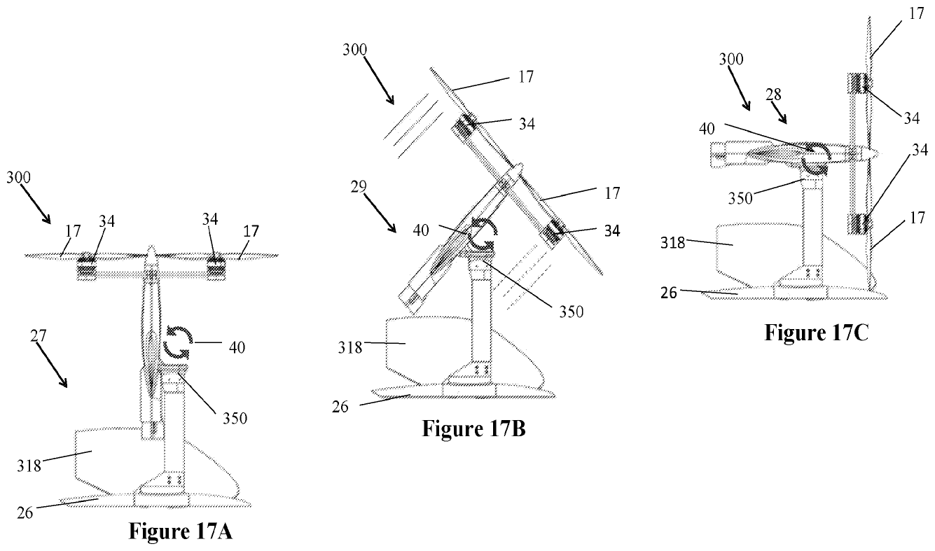

With reference to FIGS. 17A-17C, a pivot mechanism 350 pivotally connects the wing 12 to the stanchions 319 of structure 333 such that the wing 12 is selectively pivotable about a pivot axis 40, relative to the structure 333 and the payload module 318, to vary a flight path of the aircraft 300 from between a first position and a second position. This pivotal connection between the wing 12 and the stanchions 319 of the structure 333 is configured to support vertical loads, lifting loads, and additional loads due to component loading during flight of the aircraft 300. By virtue of their attachment to the wing 12, each of the electric thrust generators 34 pivot with the wing 12, about the pivot axis 40, relative to the structure 333 and the payload module 318. Pivoting the electric thrust generators 34 with the wing 12 about the pivot axis 40 provides thrust vectoring, i.e., directs the thrust in an intended direction.

Referring to FIGS. 1 and 2, the wing 12 includes the leading edge 36 and a trailing edge 37, opposite the leading edge 36. Side edges 38 along the wing chord extend to connect the leading edge 36 and the trailing edge 37. A side wing tip 321 may extend from each of the side edges 38, proximate the trailing edge 37. The side wing tips 321 may be used as flaperons 321 that pivot relative to the respective side edge 38 to assist in thrust vectoring during operation of the aircraft 300 in the VTOL mode, i.e., when the wing 12 is in the second position. The flaperons 321 may pivot relative in opposition to one another to provide a turning force (i.e., acting as an aileron), or may pivot in tandem to act together to assist with the lift/drag force (i.e., acting as flaps). The flaperons 321 may be constructed so as to pivot as a whole from a point on a root attachment of the flaperon 321 to the wing 12, where the point is chosen to provide a desired balance of forces on the wing 12. Alternatively, a portion of the flaperon 321 may be fixed relative to the wing 12, with an aft portion 221a hinged so as to move relative to the fixed portion to induce aerodynamic forces.

The wing may also include other control surfaces, such as rudders 15 and ailerons/elevators 16 proximate the trailing edge 37. Likewise, the payload module 318 may include control surfaces. As such, a rudder 15 may be operatively attached to the payload module 318 to provide additional stability and allow additional control of the flight of the aircraft 300.

The aircraft 300 is configured for vertical flight when the wing 12 and the associated electric thrust generators 34 are in the vertical flight mode 27. When the electric thrust generators 34 are selectively operating and providing thrust, and the wing 12 is in the vertical flight mode 27, the aircraft 300 flies vertically (i.e., up/down relative to ground 23), as illustrated in FIG. 17A. Likewise, the aircraft 300 is configured for horizontal, forward flight when the wing 12 and the associated electric thrust generators 34 are in the horizontal flight mode 28, as illustrated in FIGS. 13-16 and FIG. 17C 9 as elements 100-7, 100-8, and 100-9. When the electric thrust generators 34 are selectively operating and providing thrust, and the wing 12 is in the horizontal flight mode 28, the aircraft 300 flies horizontally in a forward direction, relative to the ground 23.

Each electric thrust generator 34 may include an electric motor 13 and a propeller 17. The electric motors 13 are operatively attached to the wing 12 and in electrical communication with the electrical power source 30. The propellers 17 are rotatably attached to the respective electric motor 13. In response to receiving electrical power, i.e., an electrical signal, from the electrical power source 30, the propellers 17 are configured to selectively rotate about a prop axis 43 and generate thrust to lift the aircraft 300 vertically when the wing 12 is in the second position, i.e., in a VTOL mode, and propel the aircraft 300 forward in the horizontal direction 25 when the wing 12 is in the first position. Further, with reference to FIG. 1, the outermost pair of electric thrust generators 34 may be configured to selectively rotated in a first direction that is opposite a second direction of rotation for the pair of innermost electric thrust generators 34. This counter rotation between the adjacent electric thrust generators 34 with aid in controlling stability of the aircraft 300 while the aircraft 300 is in the VTOL mode (i.e., when the wing 12 is in the second position) and when the aircraft 300 is in a transition mode (i.e., when the wing 12 is rotating between the first position and the second position).

The controller 31 may be in operative communication with the pivot mechanism 39 and each of the electric motors 13 to selectively change the orientation of the wing 12 about the pivot axis 40 and to control rotation of the propellers 17 of each of the electric thrust generators 34.

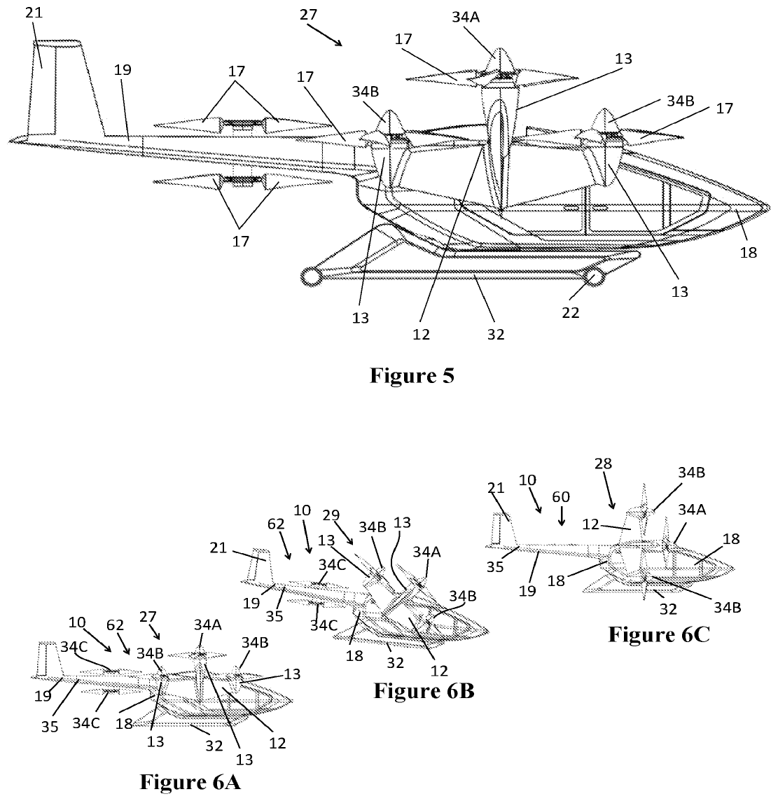

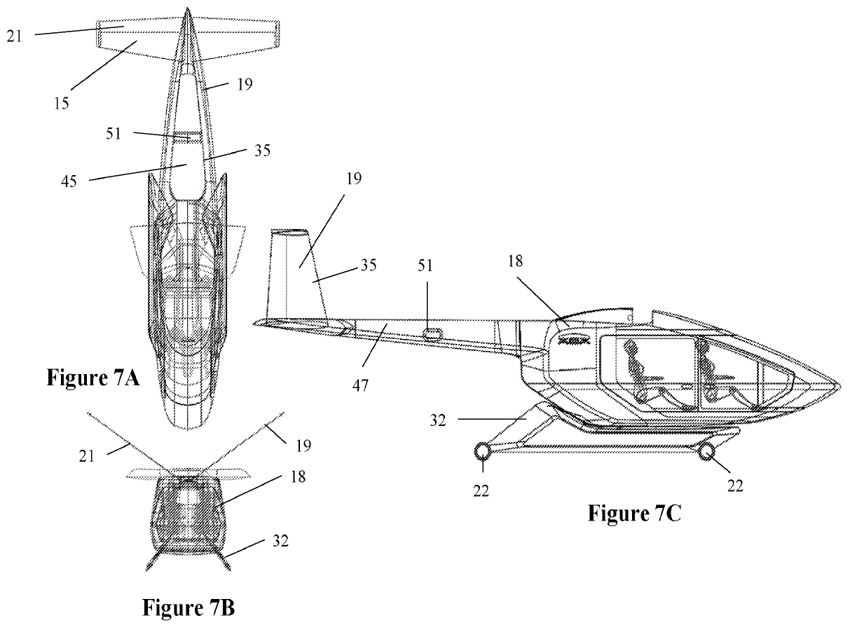

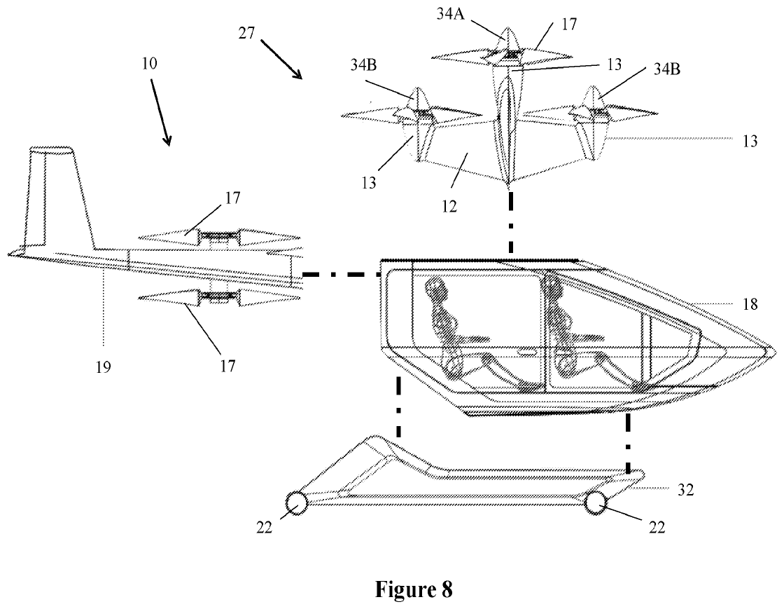

Referring again to FIG. 4, the payload module 318 may be operatively attached to the structure 333 such that the payload module 318 is movable in a fore/aft direction 42 to vary a position of the center of gravity (CG) of the aircraft 300. Allowing for the movement of the CG in the fore/aft direction 42 can provide improved stability to the aircraft 300 and optimized aircraft 300 control during aircraft takeoff, flight, landing, and transitions between vertical flight 24 and horizontal flight 25 illustrated in FIG. 5.

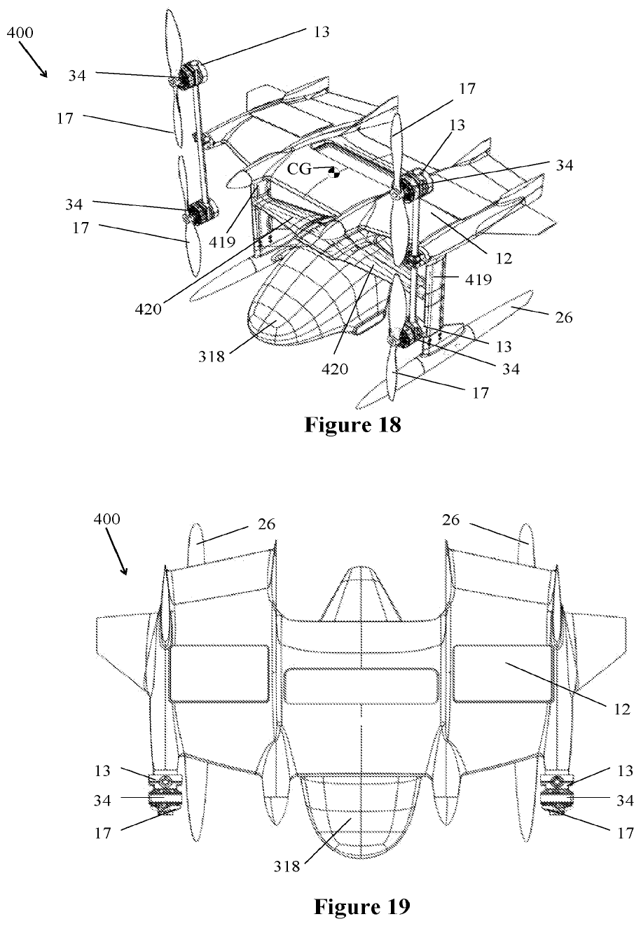

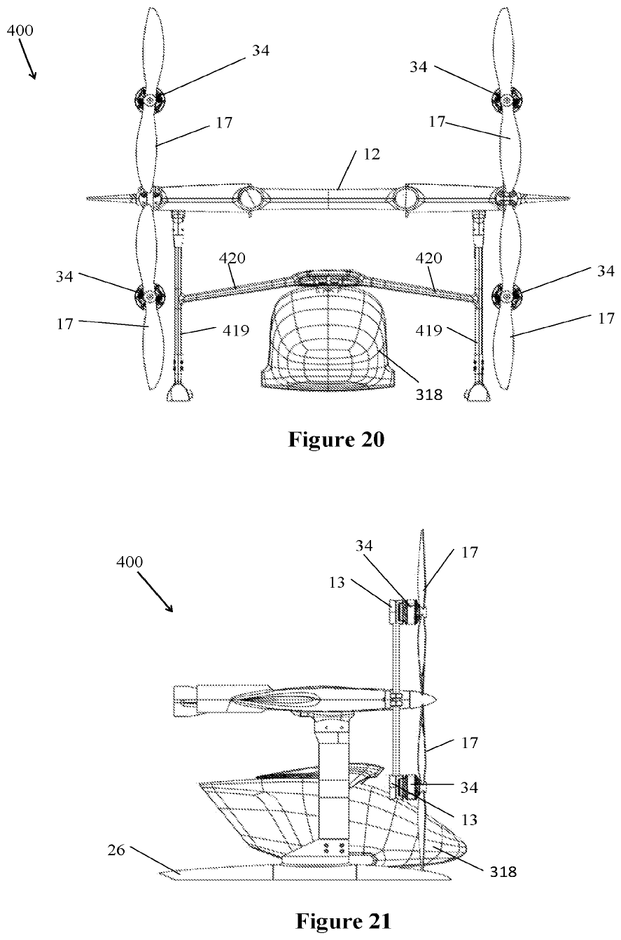

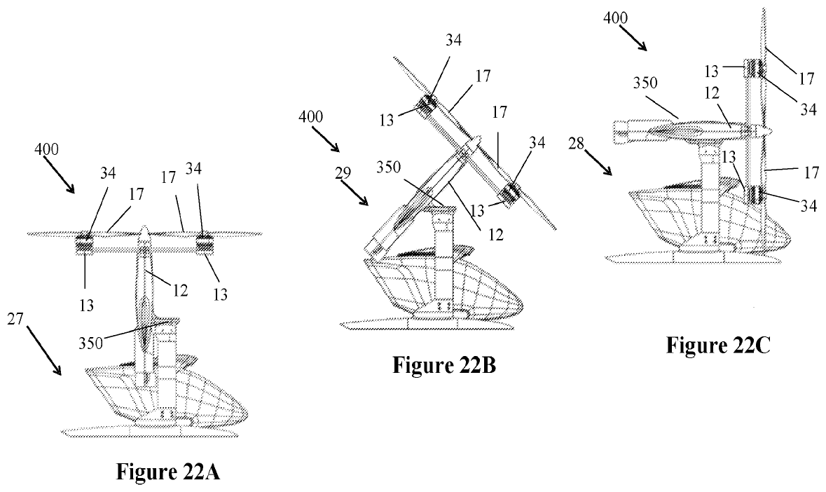

Referring to FIGS. 18-21, and 22A-22C, another embodiment of the aircraft 400 is shown. The aircraft 400 of FIGS. 18-21 and 22A-22C is identical to the aircraft of FIGS. 13-16 and 17A-17C, except that the arms 420 extend across the top of the payload module to attach the stanchions 419 to the payload module 418.

While the best modes for carrying out the many aspects of the present teachings have been described in detail, those familiar with the art to which these teachings relate will recognize various alternative aspects for practicing the present teachings that are within the scope of the appended claims.

What is claimed is:

1. An electrically powered electric vertical takeoff and landing aircraft comprising:
a payload module;
a plurality of electrical power sources;
a wing pivotally attached to the payload module and configured to selectively pivot about a pivot axis, relative to the payload module, to transition between a first position and a section position;
a plurality of electric thrust generators operatively attached to the wing, wherein each one of the plurality of electric thrust generators are operatively connected to a different one of the plurality of electrical power sources;
wherein each one of the plurality of electric thrust generators are configured to operate to provide thrust to the aircraft in response to receiving electric power from the respective one of the plurality of electrical power sources;
wherein each of the plurality of electric thrust generators pivot with the wing about the pivot axis, relative to the payload;
wherein the aircraft is configured for vertical flight when the wing is in the first position and the plurality of electric thrust generators are operating when the wing is in the first position and the aircraft is configured for horizontal forward flight, relative to the ground, when the wing is in the second position and the plurality of electric thrust generators are operating.

2. The aircraft of claim 1, wherein each one of the plurality of electric thrust generators are operatively attached to at least two of the plurality of electrical power sources.

3. The aircraft of claim 2, wherein the wing includes a hinge mechanism configured; and
further comprising a controller in operative communication with the hinge mechanism and each one of the plurality of electric thrust generators;
wherein the controller is configured to send a first control signal to the hinge mechanism to selectively vary a rotational position of the wing between the first position and the second position; and
the controller is configured to send at least one second signal to at least one of the plurality of electric thrust generators to selectively vary thrust.

4. The aircraft of claim 1, wherein the payload module is repositionably mounted to the wing such that repositioning the payload module relative to the wing moves the center of gravity (CG) of the aircraft to assist in aerodynamics as the wing transitions between vertical flight, in the first position, and horizontal flight, in the second position.

5. The aircraft of claim 4, wherein the payload module is selectively detachable from the wing and the payload module is configured to be selectively attachable to a ground module to provide ground transportation to the payload module, independent of the wing.

6. The aircraft of claim 1, further comprising landing gear operatively attached to one of the payload module and the wing;
wherein the landing gear is configured to transition between a retracted position and an extended position, such that when the landing gear is in the extended position, the landing gear supports a load of the aircraft when the aircraft is positioned on the ground, and when the landing gear is in the retracted position, the landing gear cooperates with the wing to provide an increased surface area and aspect ratio of the wing.

7. An electrically powered aircraft configured to transition between vertical flight and horizontal flight, the aircraft comprising:
a payload module;
a plurality of electrical power sources; and
a wing module pivotally attached to the payload module, wherein the wing module includes:
a wing section;
a plurality of electric thrust generators operatively attached to the wing section, wherein each one of the plurality of electric thrust generators is configured to be electrically operatively connected to at least two of the plurality of electrical power sources;
wherein each of the plurality of electric thrust generators are configured to energize in response to receiving electric power from at least one of the plurality of electrical power sources;
wherein the rotational velocity of each of the plurality of electric thrust generators is independently variable;
wherein the wing section is configured to selectively pivot about a pivot axis, relative to the payload module, to vary a flight path of the aircraft from between a first position and a second position;
wherein each of the plurality of electric thrust generators are configured to pivot with the wing section, about the pivot axis, relative to the payload;
wherein the aircraft is configured for vertical flight when the wing is in the first position and the aircraft is configured for horizontal forward flight when the wing is in the second position.

8. The aircraft of claim 7, further comprising a controller in operative communication with the wing section and each of the plurality of electric thrust generators, wherein the controller is configured to send a first control signal to the wing section to selectively vary a rotational position of the wing, and the controller is configured to send a second signals to at least one of the plurality of electric thrust generators to selectively vary a rotational speed.

9. The aircraft of claim 7, wherein the payload module is selectively detachable from the flight module and the payload is configured to be selectively attachable to a ground module to provide ground transportation to the payload module.

10. The aircraft of claim 7, wherein the payload module is repositionably mounted to the wing such that repositioning the payload module relative to the wing moves the center of gravity (CG) of the aircraft to assist in aerodynamics as the wing transitions between vertical flight, in the first position, and horizontal flight, in the second position.

11. The aircraft of claim 7, further comprising landing gear operatively attached to one of the payload module and the wing module;
wherein the landing gear is configured to transition between a retracted position and an extended position, such that when the landing gear is in the extended position, the landing gear supports a load of the aircraft when the aircraft is positioned on the ground, and when the landing gear is in the retracted position, the landing gear cooperates with the wing to provide an increased surface area and aspect ratio of the wing.
